(19) United States
(12) Patent Application Publication
(10) Pub. No.: US 2014/0282035 A1
(43) Pub. Date: Sep. 18, 2014

(54) ON-DEMAND SIMULTANEOUS SYNTHETIC APERTURE RADAR (SAR) AND GROUND MOVING TARGET INDICATION (GMTI) USING MOBILE DEVICES

(71) Applicants: Vinay Mudinoor Murthy, Elmont, NY (US); Faruk Uysal, Ridgefield Park, NY (US)

(72) Inventors: Vinay Mudinoor Murthy, Elmont, NY (US); Faruk Uysal, Ridgefield Park, NY (US)

(21) Appl. No.: 13/844,844

(22) Filed: Mar. 16, 2013

(51) Int. Cl. G06F 3/0484

(52) U.S. Cl. CPC G06F 3/0484
USPC 715/738

(57) ABSTRACT

Methods and apparatus are provided for obtaining current geographic imagery and moving target geolocations and tracks from a typically autonomous remote platform device with sensors spanning the electromagnetic spectrum through a mobile device interface. An autonomous system is provided capable of interpreting high-level commands, measuring data using multiple sensors and processing the data to generate relevant data products which expedites the data measurement/processing procedure enabling field personnel to request and receive mission-critical intelligence in a timely manner.

### STATEMENT REGARDING FEDERALLY SPONSORED RESEARCH OR DEVELOPMENT

The present invention is based upon work supported and/or sponsored by the Information Innovation Office (I20), Defense Advanced Research Projects Agency (DARPA), Arlington, Va., under SBIR Phase II Contract D11PC20007.

### FIELD OF THE INVENTION

This invention relates to methods and apparatus for remotely requesting data using a mobile device, collecting data using external sensors, subsequent processing and displaying the relevant information such as images and tracks of moving targets on the mobile device.

### BACKGROUND OF THE INVENTION

Traditional airborne remote sensing radar involves manned aircraft to make measurements (i.e. collect data) and either on-board or ground-based processors to process the data to extract meaningful information. Radar technologies have been under continuous development for the past several decades and provide a means for long-range continuous all-weather day/night observational capabilities that were not previously available. We now have the ability to perform long-distance ranging, observe large-scale weather patterns, construct digital elevation maps, measure significant changes in the earth's surface, map mineral distributions, detect moving targets and even construct images using measured radar echoes and sophisticated modern processing.

Space Time Adaptive Processing (STAP) is a well-known method used to process spatio-temporal data to detect moving targets (J. Ward, Space-time adaptive processing for airborne radar. MIT Lincoln Laboratory, Technical Report 1015, December 1994; J. R. Guerci, Space-Time Adaptive Processing for Radar. Artech House; S. U. Pillai, K. Y. Li, and B. Himed, Space Based Radar: Theory & Applications. McGraw Hill Professional, December 2007.). SAR imaging was invented in the 1950s and has since been extensively developed. It is capable of imaging large swathes of terrain and all manners of objects visible to instruments operating in the RF spectrum. Moving target indication (MTI) such as air MTI (AMTI) and ground MTI (GMTI) are heavily used in both the military and civilian sectors for monitoring air and ground traffic. MTI radars are widely used for discrete surveillance and monitoring of sensitive areas.

Along-Track Interferometry (ATI) is a well-known technique based on SAR images obtained from two phase centers separated by some distance in the along-track dimension (P.A. Rosen, Principles and Theory of Radar Interferometry, Tutorial for IGARSS, JPL Sep. 19, 2004). The advantage provided by ATI over SAR imaging alone is that by correlating the images from two different phase centers, the clutter scene (stationary background) is cancelled out and only moving targets are emphasized. ATI along with STAP has been used for target velocity estimation for endoclutter and exoclutter environments. Slow-moving targets that are within the Doppler ridge generated by the platform are referred to as being in endoclutter while targets that are external to the Doppler ridge are referred to as being in exoclutter. ATI has an advantage over STAP when estimating the velocity of targets in endoclutter whereas STAP is more efficient at detecting targets in exoclutter (R. M. Kapfer and M. E. Davis, Ultra-Wideband Multi-Mode Radar Processing, Proceedings of the 2012 IEEE Radar Conference, Atlanta, Ga. May 7-11.).

In the recent past several advances have been made in the field of robotics and autonomous aerial systems that have made unmanned aerial vehicles (UAVs) a practical and commonplace component of remote intelligence, surveillance and reconnaissance (ISR) missions. UAVs can be controlled remotely or be programmed to operate autonomously, relieving human personnel from the need to continuously interact with the system during non-critical periods.

### SUMMARY OF THE INVENTION

In at least one embodiment, an autonomous UAV, or remote platform device, is deeply integrated into a measurement/processing/decision chain in order to facilitate and expedite delivery of information and decision making capabilities. An advanced autonomous UAV system or remote platform device interprets a high level command, such as those commonly issued to human personnel, instructing it to measure data, process it and return the relevant data products to the appropriate parties.

SAR/GMTI data is a useful tool for ground personnel in tactical scenarios with limited a priori knowledge, or in scenarios where the tactical scenario is constantly in flux. Delivering geographical information via SAR maps and target geolocations via GMTI tracks enable ground personnel to tailor their strategies and decisions to suit the conditions they face. Mobile devices such as smartphones and tablets are commonly carried by these ground personnel. Allowing them to interface with an autonomous on-demand SAR/GMTI system through their mobile device gives them the flexibility to request exactly the information they require while minimizing the equipment they carry.

Target detection and tracking is a key asset in obtaining complete situational awareness. The capability to continuously monitor all vehicles within a given scenario yielding a stream of actionable information is critical to achieving superiority in tactical scenarios. ATI and space-time adaptive processing (STAP) can be integrated together with synthetic aperture radar (SAR) imaging in order to detect the presence of, and track moving targets over a long synthetic aperture by using subaperture processing (Method and Apparatus for Simultaneous Multi-Mode Processing Performing Target Detection and Tracking using Along Track Interferometry (ATI) and Space-Time Adaptive Processing (STAP), U.S. patent application Ser. No. 13/495,639 filed on Jun. 13, 2012).

Traditionally this data is measured and processed by a radar technician who passes the resulting data products to the appropriate personnel. They in turn disburse the data to field personnel who may have immediate use for it. This long chain between measurement and delivery to the relevant personnel can be eliminated by an automated system to which the field personnel have a more direct interface.

To this end we formulate an autonomous mobile system capable of measuring SAR and GMTI data on-demand, perform the requisite processing and return the pertinent information to the field personnel via a mobile device interface. The field personnel may issue a request for data of a specific area directly to the measurement and processing system via a mobile device interface. The system interprets the user's request, measures the germane data, performs the appropriate processing and returns the requested data products to the user via the mobile device. For this autonomous SAR/GMTI system, the relevant data products consist of SAR imagery and moving target geolocations forming a target track.

A useful target track should contain information gathered over a minimum of several seconds, ideally lasting a few minutes for online tracking in a tactical scenario. Over the duration of a large synthetic aperture spanning the required time duration for forming a useful target track we perform each of the three operations—SAR, ATI and STAP—over subapertures that are a fraction of the overall tracking aperture. Of the three operations, SAR and ATI require more measured information for a single output than does STAP, and their coherent processing intervals (CPIs) are identical as the ATI output is obtained by first forming two or more SAR images from the data obtained during a particular subaperture.

The CPI for SAR and ATI should be chosen to be sufficiently long such that enough information is collected in order to meet the required range and cross-range resolutions while remaining sufficiently short to ensure the target does not decohere to the point of invalidating results obtained during the subaperture. Data obtained from a minimum of two phase centers displaced by some distance in the along-track dimension are required to form a basic interferogram from which the ATI output is to be obtained. ATI yields two useful outputs: the location of the target signature which is shifted from the target's physical location due to the aberrations caused by the target's motion and an estimate for the line-of-sight velocity.

The CPI for STAP is much smaller than even the CPI for SAR, being typically on the order of a few milliseconds if not microseconds. Therefore over the course of a single subaperture it is possible to create many target velocity and angle estimates using STAP. In general a moving target has a range (slant-range or line-of-sight) and a cross-range (dimension perpendicular to range) velocity. The estimated velocity corresponds to the observed velocity along the slant-range between the platform and the target, and the estimated angle corresponds to the angle formed between the slant-range and the platform's look direction (which coincides with the normal perpendicular to the platform's path in the unsquinted case). It is sufficient to consider only two such estimates over a single subaperture provided they are sufficiently well spaced to obtain reliable estimates of the target's true velocity and heading.

Once the ATI and STAP outputs have been obtained they can be combined to estimate the physical origin of the target over the aperture under consideration using knowledge derived from conventional SAR theory. Target motion induces quantifiable and predictable aberrations, namely range and cross-range shifts of the target's signature from the target's physical location and a smearing in the cross-range dimension (Fienup, J. R. (2001). Detecting moving targets in SAR imagery by focusing. IEEE Transactions on Aerospace and Electronic Systems 2001). The former is due to the target's range velocity and the latter are due to the target's cross-range velocity. This process is performed at every subaperture along the entire tracking aperture forming a chain of estimates that can be fed into the target tracker, which in turn produces the estimated target track.

In at least one embodiment, a method is provided which includes using a computer interactive device of a mobile device to display a past map of a geographic area on a computer display of the mobile device. The method may also include sending a first request signal from the mobile device to a remote platform device concerning the geographic area. The first request signal may include a request for current data about the geographic area;

The method may further include receiving a first return signal from the remote platform device, at the mobile device, in response to the first request signal. The first return signal may have the current data about the geographic area. The current data about the geographic area may be based on the first request signal. The method may further include, at least one embodiment, displaying on a computer display of the mobile device the current data about the geographic area.

In at least one embodiment, the current data about the geographic area includes current synthetic aperture radar images about the geographic area. The current data about the geographic area may include additional current images about the geographic area. The current data about the geographic area may include current ground moving target indication tracks about the geographic area.

In at least one embodiment, the method may further include selecting a part of the past map of the geographic area using the interactive device of the mobile device, wherein the part of the past map corresponds to a part of the geographic area. The step of sending the first request signal from the mobile device to the remote platform device may concern the part of the geographic area. The first request signal may include a request for current data about the part of the geographic area. The first return signal may have the current data about the part of the geographic area. The current data about the part of the geographic area may include current synthetic aperture radar images about the part of the geographic area, and/or current ground moving target indication tracks about the part of the geographic area.

The method may further include displaying on the computer display of the mobile device a first selectable field, which is configured to be selected using the computer interactive device of the mobile device to cause the first request signal to be sent from the mobile device to the remote platform device.

The method may also include displaying on the computer display of the mobile device a second selectable field, which is configured to be selected using the computer interactive device of the mobile device to cause a second request signal to be sent from the mobile device to the remote platform device. The second request signal may request information about the operational status of the remote platform device. The method in at least one embodiment, may also include receiving a second return signal from the remote platform device, at the mobile device, in response to the second request signal; wherein the second return signal includes information about the operational status of the remote platform device which is based on the second request signal.

The method may further include displaying on the computer display of the mobile device a first selectable field, which is configured to be selected using the computer interactive device of the mobile device to cause the first request signal to be sent from the mobile device to the remote platform device.

The method, in at least one embodiment, may include displaying on the computer display of the mobile device a second selectable field, which is configured to be selected using the computer interactive device of the mobile device to cause a second request signal to be sent from the mobile device to the remote platform device; and wherein the second request signal requests information about the operational status of the remote platform device. The method may further include receiving a second return signal from the remote platform device, at the mobile device, in response to the second request signal; and wherein the second return signal includes information about the operational status of the remote platform device which is based on the second request signal.

The current data about the geographic area may include information spanning the electromagnetic spectrum about the geographic area.

The method may further include using the interactive device of the mobile device to send out a second request signal to the remote platform device; and receiving a second return signal from the remote platform device, at the mobile device, in response to the second request signal; wherein the second return signal includes information related to a mission, which a user of the mobile device is to undertake. The method may further include displaying the information related to the mission, which the user of the mobile device is to undertake, on the computer display of the mobile device.

In at least one embodiment, the method may include sending a second request signal from the remote platform device to an additional remote platform device concerning the geographic area. The second request signal may include a request for additional current data about the geographic area. The method may further include receiving a second return signal from the additional platform device, at the remote platform device, in response to the second request signal; wherein the second return signal has the additional current data about the geographic area; and wherein the additional current data about the geographic area is based on the second request signal. The method may further include receiving a third return signal from the remote platform device, at the mobile device; wherein the third return signal has the additional current data about the geographic area. In at least one embodiment, the method may further include displaying on the computer display of the mobile device the additional current data about the geographic area.

In at least one embodiment, an apparatus is provided comprising a mobile device comprising a computer processor, a computer memory, a computer interactive device, and a computer display. The computer processor of the mobile device may be programmed by computer software stored in the computer memory of the mobile device to display a past map of a geographic area on a computer display of the mobile device in response to a user input via the computer interactive device of the mobile device. The computer processor of the mobile device may be programmed by computer software stored in the computer memory of the mobile device to send a first request signal from the mobile device to a remote platform device concerning the geographic area. The first request signal may include a request for current data about the geographic area;

The computer processor of the mobile device may be programmed by computer software stored in the computer memory of the mobile device to receive a first return signal from the remote platform device, at the mobile device, in response to the first request signal; wherein the first return signal has the current data about the geographic area; and wherein the current data about the geographic area is based on the first request signal. The computer processor of the mobile device may be programmed by computer software stored in the computer memory of the mobile device to display on the computer display of the mobile device the current data about the geographic area.

The computer processor of the mobile device may be programmed by computer software stored in the computer memory of the mobile device to receive a user selection of a part of the past map of the geographic area via the interactive device of the mobile device and store the user selection in the computer memory of the mobile device; wherein the part of the past map corresponds to a part of the geographic area. The first request signal from the mobile device to the remote platform device may concern the part of the geographic area. The first request signal may includes a request for current data about the part of the geographic area; and the first return signal may have the current data about the part of the geographic area.

The computer processor of the mobile device may be programmed by computer software stored in the computer memory of the mobile device to display on the computer display of the mobile device a first selectable field, which is configured to be selected using the computer interactive device of the mobile device to cause a second request signal to be sent from the mobile device to the remote platform device; and wherein the second request signal requests information about the operational status of the remote platform device.

The computer processor of the mobile device may be programmed by computer software stored in the computer memory of the mobile device to receive a second return signal from the remote platform device, at the mobile device, in response to the second request signal. The second return signal may include information about the operational status of the remote platform device which is based on the second request signal.

In at least one embodiment, the computer processor of the mobile device may be programmed by computer software stored in the computer memory of the mobile device to display on the computer display of the mobile device a first selectable field, which is configured to be selected using the computer interactive device of the mobile device to cause the first request signal to be sent from the mobile device to the remote platform device.

In at least one embodiment, the computer processor of the mobile device is programmed by computer software stored in the computer memory of the mobile device to display on the computer display of the mobile device a second selectable field, which is configured to be selected using the computer interactive device of the mobile device to cause a second request signal to be sent from the mobile device to the remote platform device; and the second request signal requests information about the operational status of the remote platform device. The computer processor of the mobile device may be programmed by computer software stored in the computer memory of the mobile device to receive a second return signal from the remote platform device, at the mobile device, in response to the second request signal; and wherein the second return signal includes information about the operational status of the remote platform device which is based on the second request signal.

In at least one embodiment the computer processor of the mobile device is programmed by computer software stored in the computer memory of the mobile device to send a second request signal from the remote platform device to an additional remote platform device concerning the geographic area; wherein the second request signal includes a request for additional current data about the geographic area. The computer processor of the mobile device may be programmed by computer software stored in the computer memory of the mobile device to receive a second return signal from the additional platform device, at the remote platform device, in response to the second request signal; wherein the second return signal has the additional current data about the geographic area; and wherein the additional current data about the geographic area is based on the second request signal;

In at least one embodiment, the computer processor of the mobile device is programmed by computer software stored in the computer memory of the mobile device to receive a third return signal from the remote platform device, at the mobile device; wherein the third return signal has the additional current data about the geographic area. The computer processor of the mobile device may be programmed by computer software stored in the computer memory of the mobile device to display on the computer display of the mobile device the additional current data about the geographic area.

### BRIEF DESCRIPTION OF THE DRAWINGS

FIG. 1A shows a block diagram of a mobile device for use in accordance with an embodiment of the present invention;

FIG. 1B shows a block diagram of an apparatus, remote platform, or remote platform device for use in accordance with an embodiment of the present invention;

FIG. 10 shows a block diagram of an apparatus, ground based station, or ground based station device for use in accordance with an embodiment of the present invention;

FIG. 2 shows a block diagram of a user-interface-measurement system interaction wherein a user communicates via the mobile device of FIG. 1A to the remote platform of FIG. 1B in order to obtain desired information;

FIG. 3A shows a front view of a first type of mobile device, which may be used for the mobile device of FIG. 1A, with the first type of mobile device in a first state, to function as an interface between a user and the remote platform of FIG. 1B;

FIG. 3B shows a front view of the first type of mobile device of FIG. 3A, with the first type of mobile device in a second state;

FIG. 4A shows a front view of a second type of mobile device, which may be used for the mobile device of FIG. 1A, with the second type of mobile device in a first state, to function as an interface between a user and the remote platform of FIG. 1B;

FIG. 4B shows a front view of the second type of mobile device of FIG. 4A, with the second type of mobile device in a second state;

FIG. 5 illustrates a diagram of one possible type of data measurement geometry in which an airplane having the remote platform of FIG. 1B flies in a straight line while sensing in a direction perpendicular to its motion;

FIG. 6 is a high-level process flow block diagram describing a method in accordance with an embodiment of the present invention;

FIG. 7 shows a block diagram describing a method, in accordance with an embodiment of the present invention, for measuring, processing and returning data desired by the user to the mobile device of FIG. 1A;

FIG. 8 illustrates a block diagram describing generation of the desired data products and the relevant processing outputs, in accordance with an embodiment of the present invention;

FIG. 9 shows an illustration of an airplane on which the remote platform of FIG. 1B is located, taking off and travelling to a designated site and making measurements; and alternatively if the second through the fourth positions of the aircraft are considered it would represent re-routing and traveling to the designated site;

FIG. 10 illustrates a block diagram describing protocol for the platform device of FIG. 1B to follow under the conditions where either the airplane carrying the platform device of FIG. 1B has landed or is already flying.

### DETAILED DESCRIPTION OF THE DRAWINGS

FIG. 1A shows a block diagram of a mobile device 1 for use in accordance with an embodiment of the present invention. The mobile device 1 includes a computer display or monitor 2, a transmitter/receiver 4, a computer processor 6, a computer interactive device 8, and a computer memory 10. The computer display or monitor 2, the transmitter/receiver 4, the computer interactive device 8, and the computer memory 10 are connected by communications links, such as hardwired, wireless or any other type of communications links to the computer processor 6. The mobile device 1 may be a smart phone, or a tablet computer.

FIG. 1B shows a block diagram of a remote platform or remote platform device 20 for use in accordance with an embodiment of the present invention. The remote platform device 20 may include a computer display or monitor 22, a transmitter/receiver 24, a computer processor 26, a computer interactive device 28, a computer memory 30, and a sensing device 32. The computer display or monitor 22, the transmitter/receiver 24, the computer interactive device 28, the computer memory 30, and the sensing device 32 are connected by communications links, such as hardwired, wireless or any other type of communications links to the computer processor 26. The remote platform device 20 may be a personal computer. The remote platform device 20 may be located on or fixed to an airplane. The sensing device 32 may include a plurality of radar sensors and/or a plurality of electromagnetic and electro optical sensors spanning the electromagnetic spectrum. The transmitter/receiver 24 may or may not be incorporated into the sensing device 32, and/or the sensing device 32 may have its own transmitter/receiver. In at least one embodiment, it is critical that there be a plurality of sensors spanning the electromagnetic spectrum for sensing device 32 to provide complete and/or accurate data and/or information.

FIG. 10 shows a block diagram of a ground based station or ground based device 40 for use in accordance with an embodiment of the present invention. The ground based station or ground based device 40 includes a computer display or monitor 42, a transmitter/receiver 44, a computer processor 46, a computer interactive device 48, and a computer memory 50. The computer display or monitor 42, the transmitter/receiver 44, the computer interactive device 48, and the computer memory 50 are connected by communications links, such as hardwired, wireless or any other type of communications links to the computer processor 46. The ground based station device 40 may be a personal computer which is located in a grounded facility or building.

FIG. 2 shows a block diagram 200 of user-interface-measurement system interaction wherein a user 201 communicates via a mobile device 202, which may be the same as the mobile device 1 of FIG. 1A, to a remote measurement platform, such as remote platform 20 shown in FIG. 1B, in order to obtain desired information and/or data. The entirety of the interactions between the user 201 and the measurement platform, such as remote platform 20 shown in FIG. 1B, in at least one embodiment, are conducted through the mobile device 202, which in turn communicates with a data measurement and processing system controller 203. The data measurement processing system controller 203 may be part of the computer processor 26 of the remote platform 20 and/or may include or consist of a computer software program stored in computer memory 30 and executed by computer processor 26 of the remote platform 20.

The system controller 203 interprets commands received from the mobile device 202, such as via transmitter/receiver 4 and transmitter/receiver 24 and converts them to actions which are then relayed to an adaptive transmitter 204, an adaptive receiver 207 and a data product generation and storage block 208. A computer software program stored in the computer memory 20 and implemented by the computer processor 26 may implement the adaptive transmitter 204, the adaptive receiver 207, and the data product generation and storage block 208. In at least one embodiment, the adaptive transmitter 204 receives environmental and other relevant information from the controller 203 and directs the appropriate transmit waveform to a circulator 205 which in turn directs the transmit waveform to the antenna 206. A computer software program stored in the computer memory 20 and implemented by the computer processor 26 may implement the circulator 205. The antenna may be part of the transmitter/receiver 24 of the remote platform 20.

Each return echo received at the antenna 206 of the transmitter/receiver 24 of the remote platform 20, also passes through the circulator 205 of the remote platform 20 that in turn directs the received signals to the adaptive receiver 207 of the remote platform 20. The adaptive receiver 207, is programmed by computer software to perform initial processing including demodulation, analog-to-digital (ND) conversion and pulse compression. The pre-processed data is then sent to the data product generation and data storage block 208. In at least one embodiment the block 208 may be part of the remote platform 20 and in alternative embodiments, the block 208 may be part of the ground based station 40, and may be implemented by computer software stored in the computer memory 50 and implemented by the computer processor 46 of the ground based station 40. In the latter case the path between the adaptive receiver 207 and the data processing/storage block 208 typically represents a wireless data link over which the pre-processed data is transmitted from the adaptive receiver 207 of the remote platform 20 to the component 208 of the ground based station 40.

FIG. 3A shows a front view of a first type of mobile device 300 to function as the mobile device 202 and/or mobile device 1, between the user 201 and the measurement system 203 of the remote platform 20. FIG. 3A shows the mobile device 300 in a first state. Here a generic tablet computer format device 301 with a touch-screen input mechanism 302 is depicted. The touch screen input mechanism 302 displays an image 302a of the options and geographical information available prior to requesting new data, in FIG. 3A. The tablet computer 201 can be held in either a landscape position using the bezel 203 for grip as illustrated or in a portrait position rotated ninety degrees left or right from the position shown in FIG. 3A. A cable connector 204 is shown representing a charging/data transfer port by which the tablet computer 201 can be charged and/or connected to a computer system for data transfer.

In FIG. 3A the touch screen input mechanism 302 may function as both the computer display or monitor 2 and the computer interactive device 8 of FIG. 1A.

The image 302a includes fields or buttons 306, 307, 308, and 309, and map image 305. The image 302a is one possibility for a computer application screen design, with a pre-loaded map 305 that displays areas for which data can be measured. A user, such as user 101, can use the map 305 to select a geographical region of interest for which data products, data, or information can be returned, such as from the remote platform 20 to the mobile device 1. A left panel of the mobile device 300 shows four possible command fields or buttons, which can be selected including request data 306, inquire about the platform's status 307, review the mission briefing 308, and contact headquarters (HQ) 309.

FIG. 3B shows a front view of the first type of mobile device 300, with the mobile device 300 shown in a second state. In the second state, a user has activated and/or selected the command field or button 306 for “Request Data”. In the second state of FIG. 3B, the mobile device displays image 302b. While in FIG. 3A, the request data field 306 has a clear box 306a to indicate that it has not been selected, in FIG. 3B, the request data field 306 has a dark box 306b to indicate that it has been selected. If the request data 306 icon, field or button is pressed, in at least one embodiment, it is modified to show it has been selected, as shown in FIG. 3B, for 306b. Once the remote platform 20 has measured data received from the mobile device 1 and/or processed data received from the mobile device 1, the returned data products, data, and/or information, are shown on the new SAR (synthetic aperture radar) geographical map 312, shown in FIG. 3B, with a GMTI (ground moving target identification) overlaid.

FIG. 4A shows a second type of mobile device 400 in a second state, to function as the interface 202, or mobile device 1, between the user 101 and the measurement system or remote platform 20 and/or ground based system 40. Here a generic smart phone 401 with a touch-screen input mechanism 402, displaying an image 402a, is depicted. The phone 401 can be held in either a portrait position using a bezel 403 for grip as illustrated or in a landscape position rotated ninety degrees left or right from the position shown. Additional inputs such as a button 404 or a camera 405 may be used in addition to the touch screen 402 to aid issuance of directions or commands to the measurement system via the mobile device. A cable connector 406 is shown representing a charging/data transfer port by which the phone 401 can be charged and/or connected to a computer system for data transfer.

The touch screen mechanism 402 of FIG. 4A may function as both the computer display 2 and the computer interactive device 8 of the mobile device 1 of FIG. 1A.

One possibility for a computer application screen design is shown as image 402a of the options and geographical information available prior to requesting new data with a pre-loaded map section 407 with an image 407a that displays geographical areas for which data can be measured. The user can use this map 407 to select a geographical region of interest for which data products can be returned. A bottom panel shows four fields and/or buttons 408, 409, 410, and 411, having possible commands, respectively, including request data 408, review the mission briefing 409, inquire about the platform's status 410 and contact headquarters (HQ) 411, which may be part of the image 402a.

FIG. 4B shows a possible computer application screen design and/or image 402b if a user activates and/or selects one of the inputs, fields, or buttons of buttons 408, 409, 410, and 411 from the bottom panel in 400. If the request data 408 icon is pressed, it changes from a light box 408a in FIG. 4A to a dark box 408b in FIG. 4B, Once the remote platform 20 has measured data and/or processed it, the remote platform may supply and/or return data products, data and/or information to the mobile device 1 via transmitter/receivers 4 and/or 24. FIG. 4B also shows a different image 407b in the preloaded map section 407 with a new SAR geographical map with a GMTI overlay.

FIG. 5 illustrates one possible type of data measurement geometry 500 in which an airplane 505 on which is located the measuring platform device 20, flies in a straight line with velocity Vₚ while sensing data, in a direction typically perpendicular to the motion of the measuring platform device 20 on the moving airplane 505, via sensing device 32. Other measurement geometries such as circular, spotlight and scan with varying squint angles can also be used to obtain the requisite data (M. Soumekh, Synthetic Aperture Radar Signal Processing with MATLAB Algorithms, Wiley, 1999; I. G. Cumming and F. H. Wong, Digital Processing of Synthetic Aperture Radar Data: Algorithms and Implementation. Artech House Publishers, January 2005). Sensing device 32 typically includes a plurality of radar sensors and/or a collection of electromagnetic and electro optic sensors spanning the electromagnetic spectrum, which sense a plurality of items of data spanning the electromagnetic spectrum, and this plurality of items of data are stored in computer memory 30 by computer processor 26 as determined by a computer program stored in computer memory 30. The cardinal axes are x, y and z originating from point (0,0,0). In this particular measurement geometry the airplane 505 flies (and thus the platform device 20 moves in) in a straight line along the y-axis with constant velocity Vₚ and height H starting from the point (0,0,H) at time t=0.

Here a single point target 514 moving with unknown and changing velocity and unknown and changing heading v(t)e^{jψ(t)} starting from the point (x₀,y₀,0) at time t=0 and travelling along the path 517 is shown in relation to the position of the platform. The slant range Rₙ (t) at time t from the platform's position (0,Vₚt,H) 507 to the target 514 is given by Eq. (1) below

Rₙ(t)={square root over (x²(t)+(y(t)−Vₚt−nd)²+H²)} (1)

where 0≦n<N_{R} for N_{R} is the number of receivers, such as radar receivers, which are part of platform device 20 located on or attached to the airplane 505, and the target 514 position (x(t),y(t),0) is given by

x(t)=x₀+∫₀^{t}v(t) cos ψ(t)dt

y(t)=y₀+∫₀^{t}v(t) sin ω(t)dt (2)

The azimuth angle θₙ(t) between the platform and the target is given by

$${θ}_{n} ( t ) = {tan}^{- 1} ( \frac{y ( t ) - {V}_{p} t - nd}{x ( t )} ) , \qquad ( 3 )$$

the elevation angle φₙ(t) between the platform and the target is given by

$${ϕ}_{n} ( t ) = {tan}^{- 1} ( \frac{{G}_{n} ( t )}{H} ) \qquad ( 4 )$$

where the ground range Gₙ(t) in Eq. (4) above is formed by projecting the slant range Rₙ(t) onto the ground plane. The ground range is perpendicular to the line 519 joining the platform device 20 on the airplane 505 and its nadir 512, and is given by

Gₙ(t)={square root over (x²(t)+(y(t)−Vₚt−nd)²)}. (5)

These geometric relationships are utilized by computer software stored in computer memory 30 by the computer processor 26 of the platform device 20 in applying processing methods used to generate the desired data products, data, or information, such as SAR imagery and target geolocation information.

FIG. 6 illustrates a high-level process flow block diagram 600 of a method implemented by the computer processor 6 of the mobile device 1, and/or the computer processor 26 of the platform device 20, and/or the computer processor 46 of the ground based station 40 in accordance with an embodiment of the current invention. The interaction between the user 201 and the platform device 20 and/or the ground based station 40, via the mobile device interface 202 or mobile device 1 is shown in FIG. 6. The entry point for the process is at step 601 where a user activates the mobile device 1 and/or 202. In order to select a desired geographical region for which data is to be gleaned, the user 201 loads a computer application program at step 602 onto the mobile device 202 and/or stores the computer application program at step 602 into computer memory 10 of the mobile device 1, which causes the computer processor 6 of the mobile device 1 to display on the computer display 2 a pre-loaded geographical map at step 603 on the mobile device's display 302 and/or 2, containing the geographical regions for which data may be collected by the remote platform device 20. Using the displayed pre-loaded map the user selects a measurement region at step 606 on the mobile device 202 or mobile device 1, using the computer interactive device 8, such as the touch screen input mechanism 302.

The mobile device 202 or 1, then communicates to the data measurement and processing system controller 203 of the remote platform device 20 and/or the ground based station 40 the request for data at step 607. The computer processor 26 of the remote platform device 20 is programmed by computer software stored in the computer memory 30 to interpret the request for data 607 and to generate desired data products, data, or information, at step 608, and to store this data into computer memory 30, and then to supply or push the data to the mobile device 1, such as via transmitter/receivers 4 and 24, at step 609.

FIG. 7 shows a block diagram 700 describing a method, in accordance with an embodiment of the present invention, for measuring, processing and returning data from the remote platform device 20 and/or the ground based station 40 to the mobile device 1, as desired by the user of the mobile device 1. Once a request for data at step 701 has been issued by the user 201 via the mobile device 202 or device 1, such as by selecting button or field 306 for “request for data” shown in FIG. 3A, and sent from the device 1 to the device 20 and/or the device 40, and it has been determined by the computer processor 26 of the remote platform 20 and/or the computer processor 46 of the ground based station 40 that data has already been collected at step 702, the computer processor 26 and/or 46 determine whether the data has already been processed at step 704. If the data has already been processed the requested data is pushed, or sent, to the user's mobile device 1 from the remote platform device 20 and/or from the ground based station 40 by the computer processor 26 and/or the computer processor 46, respectively, at step 609, such as via transmitter/receivers 4, 24, and/or 44.

If the data has not yet been collected by the remote platform device 20 and/or the ground based station 40 then an instruction to collect the site-specific data at the designated site is issued to the platform device 20 and/or the ground based station 40 by the by the computer processor 26, as programmed by computer software stored in the computer memory 30 at step 703. Once the data has been collected by device 20 and/or device 40, after step 703, or if the data had previously been collected and not processed after step 704, then the computer processor 26 of the platform device 20 and/or the computer processor 46 of the ground based station 40 are programmed by computer software to determine if the data is to be processed on-board the remote platform device 20, at step 705. Certain large measurement platform devices for device 20 may have the capability and wherewithal to process the measured data on-board the device 20 while smaller measurement systems for the device 20 may defer the task of data processing to a ground-based processor of the ground based station 40.

If the collected data is not to be processed on-board the remote platform device 20, it must be transmitted to another data processor, such as computer processor 46 of the ground based station 40 at step 706 for data processing. Alternatively, the data may be processed at step 708 on-board the remote platform device 20 Once the desired data products, data or information have been generated by processing the data at step 708 they are pushed by computer processor 26 and/or computer processor 46 and/or transmitted from the remote platform device 20 and/or from the ground based station device 40 to the user's mobile device at step 709.

FIG. 8 illustrates a block diagram 800 describing a method in accordance with an embodiment of the present invention of generation of desired data products, data, and or information and relevant processing outputs. At step 801 measured data is passed to both a SAR/ATI processor implemented by the computer processor of the remote platform device 20 and/or of the computer processor 46 of the device 40, at step 802, which produces SAR imagery and ATI phase/magnitude data at step 803, and a STAP processor 804, implemented by the computer processor of the remote platform device 20 and/or of the computer processor 46 of the device 40, at step 804 which produces GMTI velocity and angle estimates at step 805. The pre-processed data provided at step 801 has already been demodulated (downconverted), converted from analog to digital and pulse compressed by the computer processor 26 and/or computer processor 46 in accordance with computer software stored in computer memory 30 and/or 50. Downconversion removes the carrier frequency from the received echo and centers the signal at baseband (DC).

Analog-to-digital (ND) conversion involves sampling the analog signal after passing it through an anti-aliasing filter and then quantizing the sampled waveform. Once the data passes through the ND convertor it can be pulse compressed by passing it through the matched filter h(t)=f*(T t) to the transmit signal f(t). The pre-processed data at the n^{th} receiver can be written as

sₙ(t)=γg(t−τₙ)e^{-j2πf}^{₀}^{τ}^{_{n,}} (6)

where γ is the complex-valued target reflectivity (radar cross section, RCS), f₀ is the carrier frequency, g(t)=h(t)\textcircled{*}f(t) is the matched filter output and τₙ is the two-way delay between the platform and the target. This two-way delay τₙ in Eq. (6) can be written as

cτₙ={square root over (x²(t)+(y(t)−Vₚt)²+H²)}+{square root over (x²(t)+(y(t)−Vₚ^{t}−nd)²+H²)}, (7)

which pertains to the platform-target geometry illustrated in FIG. 4.

Any of several imaging algorithms can be applied by the computer processor 26 of the remote platform 20 as determined by computer software stored in the computer memory 30 or by the computer processor 46 of the ground based station 40 as determined by computer software stored in computer memory 50, in order to obtain a SAR image, such as the range-Doppler algorithm (M. Soumekh, Synthetic Aperture Radar Signal Processing with MATLAB Algorithms, Wiley, 1999; I. G. Cumming and F. H. Wong, Digital Processing of Synthetic Aperture Radar Data: Algorithms and Implementation. Artech House Publishers, January 2005) backprojection algorithm (L. A. Gorham and L. J. Moore, SAR Image Formation Toolbox for MATLAB, In Algorithms for Synthetic Aperture Radar Imagery XVII 669, 2010).

Both of these techniques apply matched filters to the downconverted and pulse compressed data of step 801 in order to obtain focused images. Specifically for the backprojection algorithm the 2D matched filter given in the frequency domain by

H(ω,t)=F*(ω)exp(2ωτₙ), (8)

where F*(ω) is the frequency-domain representation of the pulse compression matched filter (matched to the transmit signal f(t)), which has already been applied to the received data given in Eq. (6) prior to the backprojection stage.

In order to obtain the ATI magnitude and phase, SAR images from two phase centers separated in the along-track dimension by some distance are required. The product of the first image I_{A}(x,y) and the complex conjugate of the second image I_{B}(x,y) yield the interferogram I_{AB}(x,y) with magnitude σ(x, y) and phase φ(x,y), which can be written as

I_{AB}(x,y)=I_{A}(x,y)I_{B}*(x,y)=Γ(x,y)e^{jφ(x,y)} (9)

This interferogram can also be interpreted as the zero-lag cross-correlation coefficient between the two images.

The STAP processor implemented by computer software by the computer processor 26 and/or 46, at step 804 of FIG. 8, yields velocity and angle estimates, which may be stored in computer memory 30 and/or 50, by applying the weighted joint space-time steering vector, where the unweighted steering vector is

s(θ,ω_{d})=b(ω_{d})a(θ), (10)

where b(ω_{d}) is the temporal steering vector given by

b(ω_{d})=[1e^{jπω}^{_{d}} . . . e^{jπ(M-1)ω}^{_{d}}], (11)

when M pulses are used, a(θ) is the spatial steering vector given by

$$\underline{a} ( θ ) = [ \begin{matrix}1 & {e}^{j \frac{2 π}{λ / 2}} & … & {e}^{j \frac{2 π}{λ / 2} ( {N}_{T} - 1 ) d sin θ}\end{matrix} ] \qquad ( 12 )$$

for N_{T} sensors and \textcircled{x} denotes the Kronecker product (S. U. Pillai, K. Y. Li and B. Himed. Space Based Radar: Theory & Applications. McGraw Hill Professional, December 2007). In Eq. (12) λ is the wavelength corresponding to the center frequency f₀ and d is the separation between the array elements. In order to obtain the STAP steering vector, the clutter covariance matrix R is used to weight the space-time steering vector

w=R⁻¹s(θ,ω_{d}), (13)

which is then applied to the data. The 2D peak location in the output yields estimates for the target angle θₜ and the target Doppler ω_{d}_{ₜ} which in turn yields the target's line-of-sight velocity.

Once the ATI interferogram and the STAP estimates have been obtained by the computer processor 26 and/or 46, they can be combined to yield a target geolocation for the subaperture for which the data was measured by a geolocation estimator at step 806 of FIG. 8. A geolocation estimator method and apparatus is shown in U.S. patent application Ser. No. 13/495,639 filed on Jun. 13, 2012, incorporated by reference herein. The geolocations determined by computer processor 26 and/or 46 can then be fed to a target tracker processor, which may be implemented by computer processor 26 and/or 46 in accordance with computer software stored in computer memory 30 and/or 50 at step 807, which produces a target track or target track data which may be stored in computer memory 30 and/or 50 at step 808.

The target track produced at step 808 can be fed back to the target tracker processor 807 implemented by computer processor 26 and/or 46 to improve tracking performance, and in turn the target tracker 707 can feed back useful data to the geolocation estimator at step 806 in order to improve baseline geolocation performance. The data products, data, and/or information yielded by this stage of the data measurement and processing system implemented by processor 26 and/or 46 are the SAR imagery data at step 803 from the SAR/ATI processor 802 and the target track data at step 808 from the target tracker process at step 807, all of which can be determined by computer processor 26 and/or 46 and stored in computer memory 30 and/or 50.

FIG. 9 shows an illustration 900 of an airplane 905 having the platform device 20, with the airplane 905 taking off at location 903 from a landed location 901 following path 902a and travelling to a designated site 906 and making measurements, such as with a plurality of radar receivers, and/or other electromagnetic or electro optic sensors, that are typically part of sensing device 32 shown in FIG. 1B. In the case where the airplane 905 is landed at location 901 then in order to make the measurements, the airplane 905 must take off at location 903 following a path 902b towards the designated collection site, such as 906. The cardinal directions are given by the x axis, the y axis and the z axis with reference to the origin (0,0,0).

The platform device 20 on the airplane 905 in FIG. 9 starts at ground height with at the point (x_{g},y_{g},0) and takes off at location 903 following flight path 902. As the platform device 20 on the airplane 905 draws close to the designated collection site 906 as denoted by position or location 904, the platform device 20 begins to transmit and receive SAR/GMTI data pertaining to the region 906, such as programmed and determined by computer processor 26, sensed via radar receivers and/or other electromagnetic or electro optic sensors transmitted and/or received by transmitter/receiver 24. As the airplane 905 flies nearby the collection site 906, the remote platform device 20 on the airplane 905 continues to collect data, and to store the data into computer memory 30, until a sufficient amount of data has been measured in order to satisfy the processing requirements for both SAR and GMTI.

Alternatively, if the platform device 20 on the airplane 905 is already airborne and must re-route to arrive at the designated collection site 906, travelling from position 904 to position 905a along path 902c might be considered the re-routed path of the platform device 20. In this case the platform device 20 does not follow path 902 from position 901 rather it joins the path 902 from some other arbitrary position not illustrated by the diagram 900.

FIG. 10 illustrates a block diagram 1000 describing the protocol or method for the platform device 20 to follow under the conditions where either the platform device 20 has landed or is already flying. An instruction to measure data at step 1001 is issued to the platform device 20 by the computer processor 26 as programmed by computer software stored in the computer memory 30 and implemented by computer processor 36 and selected by a user through interactive device 8, if the requested data has not already been measured by the remote platform device 20. The first question the remote platform device 20 must determine the answer to is “is the platform already airborne” at step 1002. If the answer is positive then the computer processor 26 of the platform device 20 is programmed by computer software stored in computer memory 30 to re-route the airplane 905, for example, and thus the platform device 20 at step 1004 to the designated collection site at step 1005. Depending on other prevailing conditions the platform device 20 may be programmed to re-route the airplane 905 immediately or after completing one or more tasks currently in its command queue. If the answer is negative then the platform device 20 is programmed by computer software to cause the airplane 905 to take off at step 1003 and head toward the designated collection site at step 1005. Once the platform device 20 has arrived at the designated location it will then collect the requisite data, such as via radar sensors.

Data collection devices or sensors, such as radar sensors or other electromagnetic or electro optic sensors, may be part of the transmitter/receiver 24 and/or the transmitter/receiver 44 and can be used for collecting requisite data.

We claim:

1. A method comprising using a computer interactive device of a mobile device to display a past map of a geographic area on a computer display of the mobile device;
sending a first request signal from the mobile device to a remote platform device concerning the geographic area;
wherein the first request signal includes a request for current data about the geographic area;
receiving a first return signal from the remote platform device, at the mobile device, in response to the first request signal; and
wherein the first return signal has the current data about the geographic area;
and wherein the current data about the geographic area is based on the first request signal;
and further comprising displaying on the computer display of the mobile device the current data about the geographic area.

2. The method of claim 1 wherein
the current data about the geographic area includes current synthetic aperture radar images about the geographic area.

3. The method of claim 1 wherein
the current data about the geographic area includes additional current images about the geographic area.

4. The method of claim 1 wherein
the current data about the geographic area includes current ground moving target indication tracks about the geographic area.

5. The method of claim 1 further comprising
selecting a part of the past map of the geographic area using the interactive device of the mobile device, wherein the part of the past map corresponds to a part of the geographic area;
wherein the step of sending the first request signal from the mobile device to the remote platform device concerns the part of the geographic area;
wherein the first request signal includes a request for current data about the part of the geographic area; and
wherein the first return signal has the current data about the part of the geographic area.

6. The method of claim 5 wherein
the current data about the part of the geographic area includes current synthetic aperture radar images about the part of the geographic area

7. The method of claim 5 wherein
the current data about the part of the geographic area includes current ground moving target indication tracks about the part of the geographic area.

8. The method of claim 1 further comprising
displaying on the computer display of the mobile device a first selectable field, which is configured to be selected using the computer interactive device of the mobile device to cause the first request signal to be sent from the mobile device to the remote platform device.

9. The method of claim 8 further comprising
displaying on the computer display of the mobile device a second selectable field, which is configured to be selected using the computer interactive device of the mobile device to cause a second request signal to be sent from the mobile device to the remote platform device; and
wherein the second request signal requests information about the operational status of the remote platform device; and
further comprising receiving a second return signal from the remote platform device, at the mobile device, in response to the second request signal; and
wherein the second return signal includes information about the operational status of the remote platform device which is based on the second request signal.

10. The method of claim 5 further comprising
displaying on the computer display of the mobile device a first selectable field, which is configured to be selected using the computer interactive device of the mobile device to cause the first request signal to be sent from the mobile device to the remote platform device.

11. The method of claim 10 further comprising
displaying on the computer display of the mobile device a second selectable field, which is configured to be selected using the computer interactive device of the mobile device to cause a second request signal to be sent from the mobile device to the remote platform device; and
wherein the second request signal requests information about the operational status of the remote platform device; and
further comprising receiving a second return signal from the remote platform device, at the mobile device, in response to the second request signal; and
wherein the second return signal includes information about the operational status of the remote platform device which is based on the second request signal.

12. The method of claim 3 wherein
the current data about the geographic area includes information spanning the electromagnetic spectrum about the geographic area.

13. The method of claim 1 further comprising
using the interactive device of the mobile device to send out a second request signal to the remote platform device;
receiving a second return signal from the remote platform device, at the mobile device, in response to the second request signal;
wherein the second return signal includes information related to a mission, which a user of the mobile device is to undertake;
and further comprising displaying the information related to the mission, which the user of the mobile device is to undertake, on the computer display of the mobile device.

14. The method of claim 1 further comprising
sending a second request signal from the remote platform device to an additional remote platform device concerning the geographic area;
wherein the second request signal includes a request for additional current data about the geographic area;
receiving a second return signal from the additional platform device, at the remote platform device, in response to the second request signal; and
wherein the second return signal has the additional current data about the geographic area;
and wherein the additional current data about the geographic area is based on the second request signal;
receiving a third return signal from the remote platform device, at the mobile device
wherein the third return signal has the additional current data about the geographic area;
and further comprising displaying on the computer display of the mobile device the additional current data about the geographic area.

15. An apparatus comprising
a mobile device comprising
a computer processor;
a computer memory;
a computer interactive device; and
a computer display;
wherein the computer processor of the mobile device is programmed by computer software stored in the computer memory of the mobile device to display a past map of a geographic area on a computer display of the mobile device in response to a user input via the computer interactive device of the mobile device;
wherein the computer processor of the mobile device is programmed by computer software stored in the computer memory of the mobile device to send a first request signal from the mobile device to a remote platform device concerning the geographic area;
wherein the first request signal includes a request for current data about the geographic area;
wherein the computer processor of the mobile device is programmed by computer software stored in the computer memory of the mobile device to receive a first return signal from the remote platform device, at the mobile device, in response to the first request signal; and
wherein the first return signal has the current data about the geographic area;
and wherein the current data about the geographic area is based on the first request signal;
and wherein the computer processor of the mobile device is programmed by computer software stored in the computer memory of the mobile device to display on the computer display of the mobile device the current data about the geographic area.

16. The apparatus of claim 15 wherein
the computer processor of the mobile device is programmed by computer software stored in the computer memory of the mobile device to receive a user selection of a part of the past map of the geographic area via the interactive device of the mobile device and store the user selection in the computer memory of the mobile device; wherein the part of the past map corresponds to a part of the geographic area;
wherein the first request signal from the mobile device to the remote platform device concerns the part of the geographic area;
wherein the first request signal includes a request for current data about the part of the geographic area; and
wherein the first return signal has the current data about the part of the geographic area.

17. The apparatus of claim 15 wherein
the computer processor of the mobile device is programmed by computer software stored in the computer memory of the mobile device to display on the computer display of the mobile device a first selectable field, which is configured to be selected using the computer interactive device of the mobile device to cause a second request signal to be sent from the mobile device to the remote platform device; and
wherein the second request signal requests information about the operational status of the remote platform device; and
wherein the computer processor of the mobile device is programmed by computer software stored in the computer memory of the mobile device to receive a second return signal from the remote platform device, at the mobile device, in response to the second request signal; and
wherein the second return signal includes information about the operational status of the remote platform device which is based on the second request signal.

18. The apparatus of claim 15 wherein
the computer processor of the mobile device is programmed by computer software stored in the computer memory of the mobile device to display on the computer display of the mobile device a first selectable field, which is configured to be selected using the computer interactive device of the mobile device to cause the first request signal to be sent from the mobile device to the remote platform device.

19. The apparatus of claim 18 wherein
the computer processor of the mobile device is programmed by computer software stored in the computer memory of the mobile device to display on the computer display of the mobile device a second selectable field, which is configured to be selected using the computer interactive device of the mobile device to cause a second request signal to be sent from the mobile device to the remote platform device; and
wherein the second request signal requests information about the operational status of the remote platform device;
wherein the computer processor of the mobile device is programmed by computer software stored in the computer memory of the mobile device to receive a second return signal from the remote platform device, at the mobile device, in response to the second request signal; and
wherein the second return signal includes information about the operational status of the remote platform device which is based on the second request signal.

20. The apparatus of claim 15
wherein the computer processor of the mobile device is programmed by computer software stored in the computer memory of the mobile device to send a second request signal from the remote platform device to an additional remote platform device concerning the geographic area;
wherein the second request signal includes a request for additional current data about the geographic area;
wherein the computer processor of the mobile device is programmed by computer software stored in the computer memory of the mobile device to receive a second return signal from the additional platform device, at the remote platform device, in response to the second request signal; and
wherein the second return signal has the additional current data about the geographic area;
and wherein the additional current data about the geographic area is based on the second request signal;
wherein the computer processor of the mobile device is programmed by computer software stored in the computer memory of the mobile device to receive a third return signal from the remote platform device, at the mobile device;
wherein the third return signal has the additional current data about the geographic area;
and wherein the computer processor of the mobile device is programmed by computer software stored in the computer memory of the mobile device to display on the computer display of the mobile device the additional current data about the geographic area.
